(19) United States
(12) Patent Application Publication
(10) Pub. No.: US 2025/0297707 A1
(43) Pub. Date: Sep. 25, 2025

(54) HYDROGEN PRESSURIZING RIG

(71) Applicant: Logan Energy Ltd., London (GB)

(72) Inventor: William Ireland, London (GB)

(73) Assignee: Logan Energy Ltd., London (GB)

(21) Appl. No.: 18/863,801

(22) PCT Filed: May 10, 2023
(86) PCT No.: PCT/EP2023/062503

§ 371 Date: Nov. 7, 2024

(30) Foreign Application Priority Data
May 10, 2022 (GB) 2206847.2

(51) Int. Cl. F17C 5/00; F17C 5/06

(52) U.S. Cl. CPC F17C 5/007; F17C 5/06; F17C 2205/0161; F17C 2205/0326; F17C 2221/012; F17C 2227/0157; F17C 2250/032; F17C 2250/0434; F17C 2250/0636; F17C 2265/065; F17C 2270/0171; F17C 2270/0176; F17C 2270/0178

(57) ABSTRACT

A hydrogen pressurizing rig (100) for pressurizing, purging, and/or reclaiming hydrogen from a hydrogen storage tank of a vehicle, the hydrogen pressurizing rig comprising: a compressor (106) comprising a compressor inlet and a compressor outlet: a supply inlet (112) coupled or couplable to a hydrogen source, the supply inlet fluidly coupled or couplable with the compressor inlet: a pressurizing outlet (118) for coupling to a storage tank to be pressurized, the pressurizing outlet fluidly coupled or couplable with the compressor outlet: a first pressure sensor (124) disposed for sensing a pressure during pressurizing of the storage tank and for outputting a first pressure signal based on the sensed pressure, the first pressure signal being indicative of a pressure within the storage tank; and a controller (126) coupled to receive the pressure signal, and being programmed and configured to control operation of the compressor such that, in use, the compressor pumps hydrogen from the supply inlet into the storage tank via the pressurizing outlet, such that a pressure ramp rate indicated by the pressure signal does not exceed a predetermined pressure ramp rate.

### FIELD OF THE INVENTION

The present invention relates to hydrogen pressurizing rigs for pressurizing hydrogen storage tanks.

The invention has been developed for pressurizing, purging, and/or reclaiming hydrogen to and/or from a hydrogen storage tank of a vehicle, and will largely be described with reference to such applications. However, the skilled person will appreciate that the invention has other applications in the field of hydrogen storage.

### BACKGROUND OF THE INVENTION

Vehicles such as buses, trucks, vans, and cars may use hydrogen as a fuel source. Such vehicles have an on-board storage tank for storing hydrogen under pressure. Typically, vehicle storage tanks are pressurized from a larger, high pressure storage vessel.

### SUMMARY OF THE INVENTION

In accordance with a first aspect, there is provided hydrogen pressurizing rig for pressurizing a storage tank, the hydrogen pressurizing rig comprising:
a compressor comprising a compressor inlet and a compressor outlet;
a supply inlet coupled or couplable to a hydrogen source, the supply inlet fluidly coupled or couplable with the compressor inlet;
a pressurizing outlet for coupling to a storage tank to be pressurized, the pressurizing outlet fluidly coupled or couplable with the compressor outlet;
a first pressure sensor disposed for sensing a pressure during pressurizing of the storage tank and for outputting a first pressure signal based on the sensed pressure, the first pressure signal being indicative of a pressure within the storage tank; and
a controller coupled to receive the pressure signal, and being programmed and configured to control operation of the compressor such that, in use, the compressor pumps hydrogen from the supply inlet into the storage tank via the pressurizing outlet, such that a pressure ramp rate indicated by the pressure signal does not exceed a predetermined pressure ramp rate.

The hydrogen pressurizing rig may comprise a user interface for receiving user input and providing it to the controller, wherein the predetermined pressure ramp rate is selectable by way of the user interface.

The hydrogen pressurizing rig may comprise a metering valve fluidly coupled between the compressor outlet and the pressurizing outlet, the metering valve being connected for control by the controller so as to modulate a rate at which hydrogen is supplied to the storage tank.

The hydrogen pressurizing rig may comprise a second pressure sensor disposed for sensing a pressure of the hydrogen source to which the supply inlet is coupled, and for outputting a second pressure signal based on the sensed pressure, wherein the controller is configured to control the metering valve to modulate the rate at which hydrogen is supplied to the storage tank based at least in part on a difference between the first and second pressure signals.

The controller may be configured to operate the compressor only in the event that a difference between the first pressure signal and the second pressure signal is insufficient to cause hydrogen to flow from the hydrogen source to the storage tank at an acceptable rate.

The pressurizing outlet may comprise a plurality of pressurizing connectors, each of the pressurizing connectors being configured for attachment to a different type of storage tank and/or connector.

The supply inlet may comprise a plurality of supply connectors, each of the supply connectors being configured for attachment to a different type of hydrogen source and/or connector.

The hydrogen pressurizing rig may comprise a frame to which the supply inlet, the pressurizing outlet, and the compressor are mounted, the hydrogen pressurizing rig being portable.

The hydrogen pressurizing rig may comprise one or more ground wheels mounted to the frame for allowing the hydrogen fueling rig to be wheeled over ground.

The hydrogen pressurizing rig may comprise a purge valve fluidly coupled with the pressurizing outlet and controllable by the controller, the hydrogen fueling rig being configured to operate in a mode for purging of a storage tank that contains a gas other than hydrogen, in which the controller is configured to:
(a) control the purge valve so as to partially purge a storage tank to which the pressurizing outlet is coupled, such that a pressure indicated by the pressure signal does not fall below a first pressure;
(b) partially fill the storage tank with hydrogen from a hydrogen source to which the supply inlet is coupled, such that a pressure indicated by the pressure signal does not rise above a second pressure; and
(c) repeat steps (a) and (b) a plurality of times;
wherein either or step (a) or step (b) may be performed first.

Step (b) may comprise operating the compressor.

The first pressure may be a minimum conditioned operating pressure and/or the second pressure may be lower than a minimum in-service rated pressure of the storage tank.

The hydrogen pressurizing rig may be operable in a reclaim mode in which the controller controls the compressor such that it extracts hydrogen from a storage tank to which it is coupled, the storage tank storing hydrogen for fueling a vehicle.

The hydrogen pressurizing rig may comprise a further pressurizing outlet for coupling to a storage tank to be pressurized, the pressurizing outlet fluidly coupled or couplable with the compressor outlet, at least one valve being controllable by the controller for reconfiguring a fluid connection to at least one of the pressurizing outlets such that it is fluidly connected to the compressor inlet, such that hydrogen can be reclaimed from a storage tank through the reconfigured pressurizing outlet, and used by the compressor to pressurize a storage tank through one of the pressurizing outlets that is not reconfigured.

In accordance with a second aspect, there is provided a hydrogen pressurizing rig comprising:
a compressor;
a first pressure sensor disposed downstream of the compressor for sensing a pressure of gas within a storage tank and for outputting a first pressure signal based on the sensed pressure, the first pressure signal being indicative of that pressure; and
a controller coupled to receive the pressure signal;
the hydrogen pressurization rig being configured to operate in a purge mode for purging of a storage tank that contains a gas other than hydrogen, in which the controller is configured to:
   (a) control the purge valve so as to partially purge a storage tank to which the hydrogen fueling rig is coupled, such that a pressure indicated by the pressure signal does not fall below a first pressure;
   (b) partially fill the storage tank with hydrogen from a hydrogen source to which the hydrogen fueling rig is coupled, such that a pressure indicated by the pressure signal does not rise above a second pressure; and
   (c) repeat steps (a) and (b) a plurality of times;
   wherein either or step (a) or step (b) may be performed first.

Step (b) may comprise operating the compressor.

The controller may be configured to control the compressor such that a pressure ramp rate indicated by the pressure signal does not exceed a predetermined pressure ramp rate.

In accordance with a third aspect, there is provided a hydrogen pressurizing system comprising:
a first hydrogen pressurizing rig according to the first or second aspect; and
a second hydrogen pressurizing rig according to the first or second aspect;
wherein the first hydrogen pressurizing rig compresses hydrogen and outputs it at a first pressure to the second hydrogen pressurizing rig, and the second hydrogen pressurizing rig further compresses the hydrogen and outputs it at a second pressure that is higher than the first pressure.

### BRIEF DESCRIPTION OF THE DRAWINGS

Aspects and implementations will now be described, without limitation and by way of example only, with reference to the accompanying drawings, in which:

FIG. 1 is a schematic of a further hydrogen pressurizing rig, a hydrogen supply, and a vehicle;

FIG. 2 is a schematic of a hydrogen pressurizing rig;

FIG. 3 is a schematic of a further hydrogen pressurizing rig;

FIG. 4 is a schematic of a further hydrogen pressurizing rig, a hydrogen supply, and a vehicle;

FIG. 5 is a simplified side view of a portable hydrogen pressurizing rig;

FIG. 6 is a schematic of a controller;

FIG. 7 is a perspective view of a hydrogen pressurizing rig;

FIG. 8 is a graph showing a pressure within a storage tank against time; and

FIG. 9 is a schematic of a further hydrogen pressurizing rig.

### DETAILED DESCRIPTION OF THE INVENTION

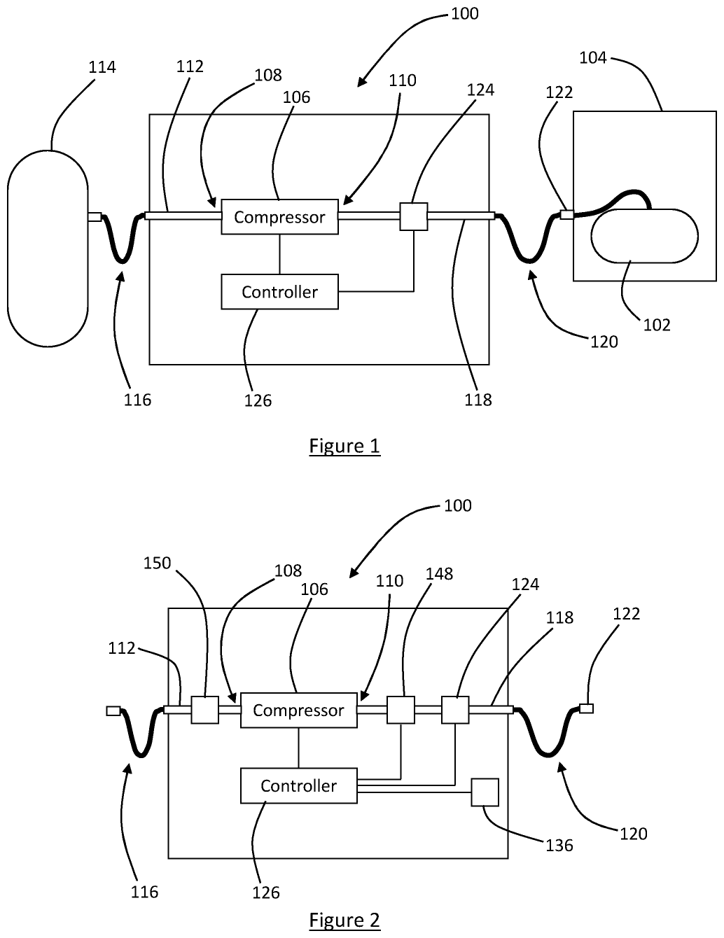

Referring to the drawings, FIG. 1 shows a hydrogen pressurizing rig 100 for pressurizing a storage tank 102. In FIG. 1, storage tank 102 is a hydrogen fuel tank mounted within a bus 104, although many other automobiles, including trucks, vans, and cars, have similar hydrogen storage tanks that can be pressurized by the hydrogen pressurizing rigs described herein. The skilled person will appreciate that rig 100 may be used to pressurize storage tanks in non-automobile applications too.

Rig 100 includes a compressor 106, comprising a compressor inlet 108 and a compressor outlet 110. In FIG. 1, compressor 106 is a reciprocating piston compressor, although any other suitable compressor type, including a diaphragm compressor, may be employed in other implementations. Compressor 106 may have any suitable power rating. In one implementation, the compressor may be a 4.5 kW electrically powered compressor. In another implementations, the compressor may be an 11 kW electrically powered compressor.

Rig 100 includes a supply inlet 112. In FIG. 1, supply inlet 112 is coupled to a hydrogen source in the form of a manifolded cylinder pallet (MCP) 114, by way of an inlet hose 116. Inlet hose 116 is connected to MCP 114 by way of a quick-release connector (not shown).

The skilled person will appreciate that the hydrogen source may take any other suitable form, including, for example, one more or high-pressure hydrogen vessels, and lower pressure sources such as electrolysers. Inlet hose 116 is connected to supply inlet 112 by way of a quick-release connector (not shown).

Supply inlet 112 is fluidly coupled with compressor inlet 108 by way of a connector (not shown), such that hydrogen from MCP 114 can enter compressor 106 when rig 100 is in use, as described in detail below.

Rig 100 includes a pressurizing outlet 118 that is fluidly coupled with compressor outlet 110 by way of a connector (not shown). Pressurizing outlet 118 is coupled to storage tank 102 by way of an outlet hose 120. Outlet hose 120 is connected to storage tank 102 by way of a nozzle 122. Nozzle 122 is a standard fueling nozzle designed for use in pressurizing a hydrogen fuel tank of a vehicle.

Although not shown, the skilled person will appreciate that there exist standard communication protocols for allowing storage tanks, such as storage tank 102, to communicate with apparatus such as rig 100. Such communication protocols allow rig 100 to determine factors such as a maximum allowable pressure and pressure ramp rate, without the need for a user to manually input information.

A first pressure sensor 124 is disposed for sensing a pressure during pressurizing of storage tank 102. In FIG. 1, first pressure sensor 124 is positioned between compressor outlet 110 and pressurizing outlet 118, although in other implementations may be positioned at any suitable position downstream of compressor 106.

As described in more detail below, first pressure sensor 124 is configured to output a first pressure signal based on the sensed pressure, the first pressure signal being indicative of a pressure within storage tank 102.

Rig 100 includes a controller 126 coupled to receive the pressure signal from first pressure sensor 124. Controller 126 is shown schematically in FIG. 6, and includes a processor 128, a memory 130, I/O block 132 for sending and receiving information as described in more detail below, and a user interface (UI) block 134 for displaying and accepting user input via, for example, a touchscreen display 136, all connected in a known manner.

Controller 126 may take the form of, for example, a microcontroller that integrates processor 128, memory 130, I/O block 132, and UI block 134. Alternatively, any or all of these functions may be distributed across one or more microprocessors, processers, memory units, I/O components, and UI components, any or all of which may be separate or integrated with each other in any combination. Controller 126 may alternatively take the form of a general purpose computer suitably programmed and configured to provide the described functionality.

Controller 126 is controlled by one or more programs stored in memory 130. In particular, and as described in more detail below, controller 126 is programmed and configured to control operation of compressor 106 such that, in use, compressor 106 pumps hydrogen from supply inlet 112 (and hence from MCP 114) into storage tank 102 via pressurizing outlet 110, such that a pressure ramp rate indicated by the first pressure signal does not exceed a predetermined pressure ramp rate. Ramp rate may be particularly important with Type IV cylinders, as these have liners that may be damaged if ramp rates and temperature limits are exceeded.

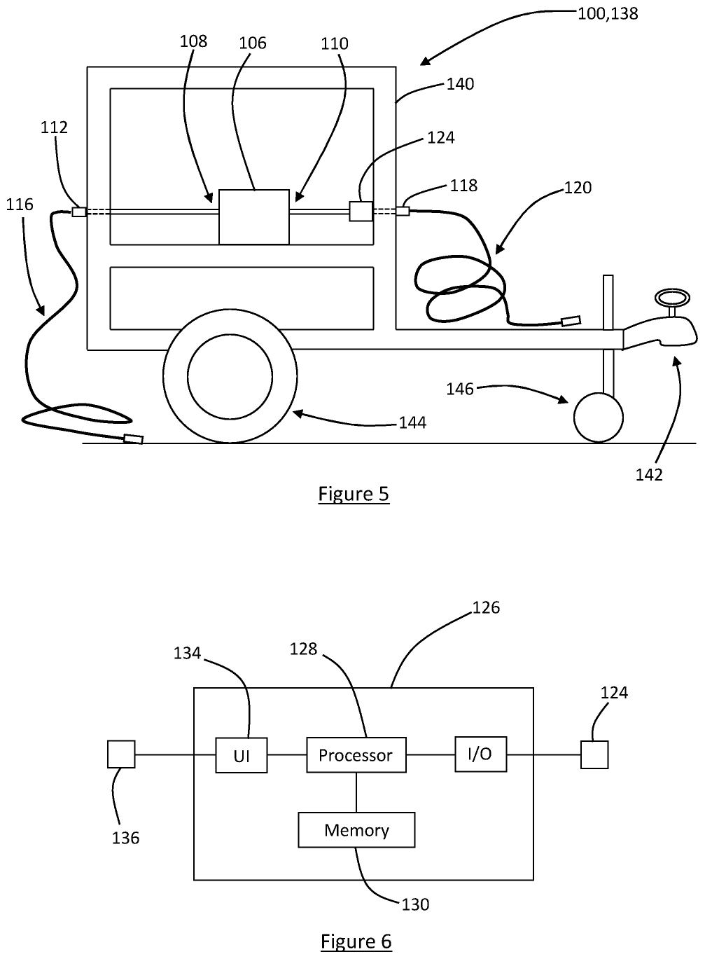

Hydrogen pressurizing rig 100 is optionally portable, in the sense that it is designed to be moved around rather than installed in a permanent location. One example of a portable hydrogen pressurizing rig 100 is shown in FIG. 5, in which rig 100 takes the form of a trailer 138 that includes a frame 140. Frame 140 may comprise, for example, steel and/or aluminium subframe components (not shown), which are welded, bolted or otherwise connected to together, although the skilled person will appreciate that any other material(s) and/or construction methods may be employed.

Frame 140 includes a towing hitch 142 that can be releasably attached to a corresponding towball on a towing vehicle such as a car, truck, or van (not shown). Rig 100 also includes ground wheels 144 mounted to an axle (not shown) attached to frame 140. Trailer 138 can be attached to the towing vehicle by way of the towing hitch 142, and then driven to a location for use.

Optionally, rig 100 can be removed from the towing vehicle, in which case a wheelstand 146 may be used to stabilize and adjust the pitch of trailer 138 such that frame 140 is sufficiently level. When wheelstand 146 is in use, trailer 138 may be manually positioned by one or more users. A parking brake (not shown) may be used to prevent trailer 138 from moving once it is in position for use.

Supply inlet 112, pressurizing outlet 118, and compressor 106 are mounted to frame 140. For example, supply inlet 112, pressurizing outlet 118, and compressor 106 may each be independently attached to frame 140 by way of direct connection with, for example, bolts, screws, clamps, brackets or the like,

The skilled person will appreciate that, in this context, “mounted” includes both direct and indirect mounting. For example, only compressor 106 may be mounted directly to frame 140, with supply inlet 112 and pressurizing outlet 118 mounted to compressor 106. In that example, supply inlet 112 and pressurizing outlet 118 are indirectly mounted to frame 140 by way of being mounted to compressor 106. Any or all other components and elements described within this application may also, optionally, be mounted, directly or indirectly, to frame 140.

Rig 100 includes a 3-phase plug and cable (not shown) that can be plugged into a 3-phase outlet to power compressor 106, controller 126, and other electrically-powered components. The skilled person will appreciate that other sources of power may be used, such as an onboard generator or battery for example.

In other implementations, rig 100 may omit wheels 144, and may take any other suitable form. Rig 100 may remain portable without wheels, by way of frame 140 being designed to allow it to be moved between different locations. For example, frame 140 may be configured to allow it to be moved around by a forklift, telehandler, crane, hoist, or other form of mechanical lifting device. In yet other implementations, frame 140, and the components it carries, may be sufficiently lightweight to allow safe lifting and movement of rig 100 by one or more human operators. In the absence of wheels 144, frame 140 may optionally include one or more legs, feet, pads, or other support elements upon which frame 140 rests on the ground or another surface (such as the bed of a truck or van).

In yet other implementations, rig 100 may include one or more driven wheels, allowing it to be self-driven. In such implementations, rig 100 may take the form of a vehicle, or may alternatively take the form of a powered cart, movement of which is controlled by a user using controls (not shown) on the cart, or a remote control unit (not shown).

In use, rig 100 is positioned adjacent bus 104. MCP 114, which may be on a movable cart or trailer, is positioned adjacent rig 100. Inlet hose 116 is connected to a corresponding connector on MCP 114, and nozzle 122 is connected to a corresponding receptacle on bus 104.

The skilled person will appreciate that any of rig 100, bus 104, and MCP 114 may have limitations on their movement. For example, MCP 114 may be installed in a static location, in which case rig 100 and bus 104 will need to be moved sufficiently close to MCP 114.

Each of rig 100, storage tank 102 and MCP 114 may include one or more safety features, including hardware and software interlocks that prevent or inhibit user error in connecting and using rig 100 to pressurize storage tank 102 with hydrogen. Such safety features are well known to those skilled in the art, and so will not be described in further detail.

Storage tank 102 communicates with controller 126 by way of the protocols described above, supplying information indicative of a maximum pressure and maximum ramp rate applicable to storage tank 102. Controller 126 monitors the first pressure signal from first pressure sensor 124 and controls operation of compressor 106 to pump hydrogen from supply inlet 112 into the storage tank 102 via pressurizing outlet 118, such that a pressure ramp rate indicated by changes in the first pressure signal over time does not exceed the maximum pressure ramp rate of storage tank 102.

Compressor 106 is controlled by controller 126 to ensure that hydrogen is supplied through pressurizing outlet 118 at sufficient pressure to achieve a required target pressure (which may differ from the storage tank's maximum pressure). Where hydrogen is supplied at a pressure above that indicated by the first pressure signal, it may be sufficient to allow hydrogen to pass through compressor 106 without compressor 106 further compressing it. This may happen automatically as a result of hydrogen bypassing one or more check valves (not shown) within compressor 106. When the first pressure signal indicates that the pressure is no longer rising, or is not rising fast enough, controller 126 controls compressor 106 such that it increases the pressure at which the hydrogen is supplied to storage 102.

Turning to FIG. 2, there is shown an alternative implementation, in which components corresponding with those in FIG. 1 are indicated with like reference signs. In FIG. 2, rig 100 includes a metering valve 148 fluidly coupled between compressor outlet 110 and pressurizing outlet 118. Metering valve 148 is connected for control by controller 126, so as to modulate a rate at which hydrogen is supplied to storage 102. Metering valve may take the form of an electro-pneumatic actuator valve of the type known to the skilled person, although any other suitable type of metering valve may be used in different implementations.

By controlling metering valve 148, a higher-pressure MCP (or other hydrogen source) may be used. For example, where hydrogen is supplied at a pressure significantly above that indicated by the first pressure signal, controller 126 may control metering valve 148 to allow hydrogen through at a sufficient rate that the pressure indicated by the first pressure signal rises at a rate that does not exceed the maximum ramp rate. If the first pressure signal indicates that the pressure is no longer rising, or is not rising fast enough, controller 126 controls compressor 106 such that it increases the pressure at which the hydrogen is supplied to storage 102.

In some cases, hydrogen may be supplied by MCP 114 (or other hydrogen source) at a pressure that is higher than the target pressure for storage tank 102. In that case, controller may control metering valve 148 as described above, without needing to use compressor 106 to increase a pressure of the hydrogen passing through it.

The rig 100 of FIG. 2 has the advantage of being usable with hydrogen supplies having significantly different pressures. As explained above, relatively low pressure supplies can be pressurized by compressor 106 to give a desired pressure ramp rate, and relatively high pressure supplies can be modulated by way of metering valve 148 to prevent a desired pressure ramp rate from being exceeded. This provides rig 100 with considerable flexibility, allowing its use in many different scenarios.

Further flexibility can be offered by coupling an additional pressure sensor for sensing a pressure of the hydrogen source to which supply inlet 112 is coupled. For example, FIG. 2 shows an optional second pressure sensor 150 coupled between supply inlet 112 and compressor inlet 108. Second pressure sensor 150 is configured to output a second pressure signal based on the sensed pressure. Where second pressure sensor 150 is included, controller 126 can be configured to control metering valve 148 to modulate the rate at which hydrogen is supplied to storage tank 102 based at least in part on a difference between the first and second pressure signals. For example, controller 126 may be configured to operate compressor 106 only in the event that a difference between the first pressure signal and the second pressure signal is insufficient to cause hydrogen to flow from the hydrogen source to storage tank 102 at an acceptable or desirable rate.

Turning to FIG. 3, there is shown an alternative implementation, in which components corresponding with those in FIGS. 1 and/or 2 are indicated with like reference signs. In FIG. 3, pressurizing outlet 118 comprises a plurality of pressurizing connectors 152, 154, and 156, each being configured for attachment to a different type of storage tank and/or connector. Pressurizing connectors 152, 154, and 156 are connected to respective outlets 158, 160, and 162 of an outlet manifold 158 using suitable connectors (not shown). Depending upon the implementation, such connectors can be of a quick release type, but in the implementation of FIG. 3 are permanently installed, requiring tools for removal. This assists in reducing the chance of any of pressurizing connectors 152, 154, and 156 being accidentally connected to the wrong type of storage tank.

Outlets 158, 160, and 162 include respective in-line actuating valves 166, 168, and 170. Each of in-line actuating valves 166, 168, and 170 is controlled such that a supply pressure does not exceed the rated pressure for its corresponding pressurizing connector 152, 154, and 156. The current supply pressure may be determined based on the first pressure signal, or based on pressure signals provided by additional pressure sensors (not shown) disposed in-line with each of actuating valves 166, 168, and 170, respectively. This prevents over-pressurization of a storage tank in the event of an upstream failure that results in the compressor generating more pressure than the maximum rated pressure of the storage tanks for use with each connector type, for example.

Outlets 158, 160, and 162 optionally include respective in-line high pressure release (HPRV) valves 214, 216 and 218. The outlets of HPRV valves 214, 216 and 218 are connected to a common venting conduit 220, which vents hydrogen to the atmosphere via a vent 222 if an overpressure event occurs. Alternatively, outlets of HPRV valves 214, 216 and 218 may be connected to individually vent to atmosphere via their own vents (not shown).

Each of pressurizing connectors 152, 154, and 156 can include a hose terminating in a nozzle or other connector, for connection to a corresponding connector on a storage tank. For example, pressurizing connector 152 terminates at a quick-connect 208 suitable for high pressure (e.g., 450 bar) operation, pressurizing connector 154 terminates at a BS 341 connector 210 for use in refilling MCPs at up to 350 bar, and pressurizing connector 156 terminates at a fueling nozzle 212 for vehicle refueling.

Actuating valves 166, 168, and 170 are connected to be controlled by controller 126, and are controlled such that only one of outlets 158, 160, and 162 can be used at a time. This can be achieved by, for example, noting which of outlets 158, 160, and 162 is first connected to a storage tank, based on communication between the corresponding nozzle and its receptacle on the storage tank when the nozzle is first connected. Controller 126 can then ignore subsequent additional connections, or may queue the connections up such that the storage tanks connected to them are pressurized sequentially. The pressurization order in that case can be based on, for example, the order in which the connections were made, or chosen by a user via the user interface.

Supply inlet 112 comprises a plurality of supply connectors 172, 174, and 176, each being configured for attachment to a different type of hydrogen source and/or connector. Supply connectors 172, 174, and 176 are connected to respective inlets 178, 180, and 182 of an inlet manifold 184 using suitable connectors (not shown). Depending upon implementation, such connectors can be of a quick release type, but in the implementation of FIG. 3 are permanently installed, requiring tools removal. This assists in reducing the chance of any of supply connectors 172, 174, and 176 being accidentally connected to the wrong type of hydrogen supply.

Supply connectors 172, 174 and 176 may take any suitable form. For example, one or more of supply connectors 172, 174, and 176 may form one side of a nut and stem connection (such as those complying with ISO 5145), a ¼″ NPT, BSP fitting, or any other suitable connector or fitting.

Although FIG. 3 shows an inlet manifold and an outlet manifold, the skilled person will appreciate that in other implementations, only an inlet manifold or an outlet manifold is provided. For example, a rig 100 implementation may use the supply inlet 112 of FIG. 1 or 2 in combination with an outlet manifold 164, or the pressurizing outlet 118 of FIG. 1, 2, or 4 in combination with inlet manifold 184.

The skilled person will appreciate that the number of inlets/outlets on inlet manifold 184 and outlet manifold 164 is not limited to three as illustrated in FIG. 3, but may be selected to suit particular implementation requirements.

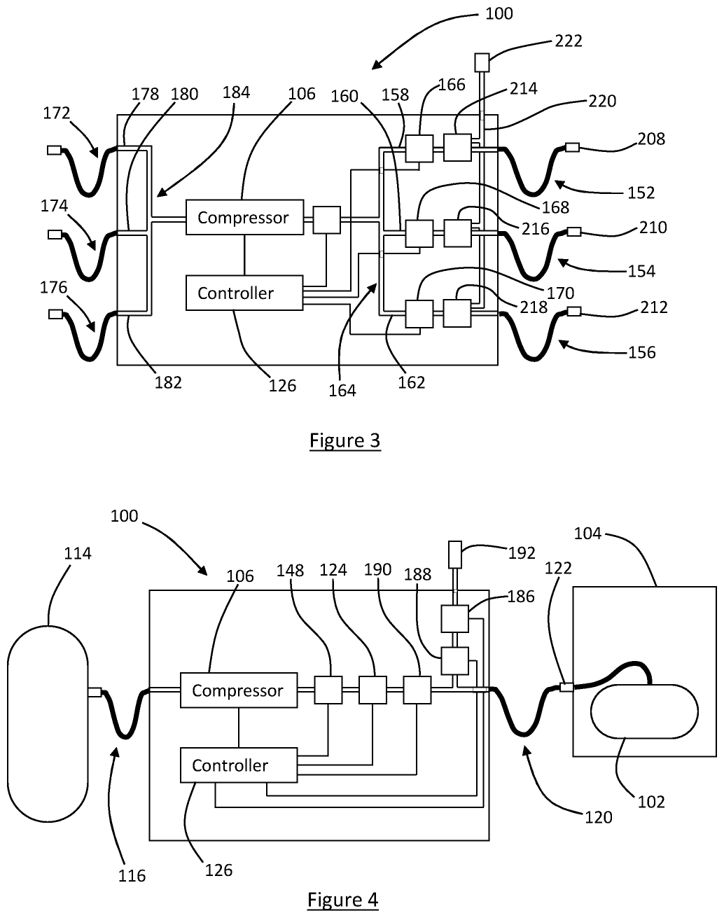

Turning to FIG. 4, there is shown an alternative implementation, in which components corresponding with those in FIGS. 1 to 3 are indicated with like reference signs. In FIG. 4, rig 100 includes a purge valve 186, which is connected for control by controller 126. Purge valve 186 is connected to pressurizing outlet 118 by way of a first control valve 188. A second control valve 190 is positioned between compressor outlet 110 and pressurizing outlet 118. First control valve 188 and second control valve 190 are connected to be controlled by controller 126. In general, when first control valve 188 is open, second control valve 190 is closed. In this way, when storage tank 102 is connected to pressurizing outlet 118, it is in fluid communication with either compressor 106 or purge valve 186, but not both. This is to avoid purge valve 186 being in communication with compressor 106, which would present a risk of hydrogen leakage. The other side of purge valve 186 is connected to a purge vent 192, to allow venting of hydrogen to atmosphere as required.

In use, purge valve 186 can be used to vent a connected storage tank to atmosphere. This ability is of particular use during an initial purge process performed on a storage tank that contains a gas other than hydrogen. For example, when a vehicle is first delivered after production, its storage tank may be filled with a gas such as nitrogen. Before the vehicle can be used, the nitrogen must be purged and replaced with hydrogen.

A vehicle storage tank generally has a number of notable pressure ratings. For example, as indicated on the vertical axis of the graph shown in FIG. 8, a particular storage tank may have the following notable pressure ratings, in increasing rank:
a first minimum, P1, corresponding to a pressure below which the storage tank should never be allowed to fall;
a first maximum, P2, corresponding to a pressure which the storage tank should not be allowed to exceed during a purge process;
a second minimum, P3, corresponding to a pressure below which the storage tank should not be allowed to fall during ordinary operation (i.e., once the vehicle is in-service after the purge process has been complete); and
a second maximum, P4, corresponding to a pressure which the storage tank should not be allowed to exceed during ordinary operation.

Although not shown to scale in FIG. 8, example values of P1-P4 for a bus hydrogen storage tank are:
P1=15
P2=23
P3=30
P4=350

In the example of FIG. 8, P2 is lower than P3, although this need not be the case in other implementations.

Controller 126 is configured to determine an appropriate number of purge cycles based on information such as P1 and P2 for the particular storage tank to be purged. The number of purges needed can be calculated based on factors such as a target purity (e.g., 99.97% purity for a vehicle using a fuel cell), ramp rates, temperature, and volumetric calculations based on pressure changes across the purging and pressurizing cycles. The calculations for determining an appropriate purging protocol are known to the skilled person and so will not be described in more detail.

Also of interest are the maximum pressure ramp rate for delivery of hydrogen during pressurization, and a maximum negative pressure ramp rate as the storage tank is vented during purging. Maximum ramp rates vary depending upon whether the hydrogen is pre-cooled, but as an example may vary between 1 and 9 bar per minute. As mentioned above, failing to adhere to a maximum ramp rate may cause damage to the liner of the storage tank being pressurized.

In alternative implementations, the appropriate number of purge cycles can be predetermined based on, for example, manufacturer- or supplier-supplied data. Such data may be stored in memory 130, and selected via the user interface by a user, or the individual parameters may be manually entered by a user via the user interface, optionally based on a template or other suitable data entry mechanism. Controller 126 may be configured to perform simple checks, such as ensuring that the pressure values (e.g., P1 and P2), and the ramp rates, seem reasonable relative to each other and overall.

The initial pressure of the nitrogen within the storage tank is indicated as P5 on the vertical axis of FIG. 8. Line 194 indicates the pressure indicated by the first pressure signal output by first pressure sensor 124.

Once the number of purge cycles and other necessary information have been input, the initial purging process can commence. First control valve 188 is opened, and second control valve 190 is closed.

At time T1, a first purge cycle commences. Controller 126 causes purge valve 186 to open, thereby venting nitrogen from the storage tank. Controller 126 monitors the changing first pressure signal to ensure that the pressure is not exceeding the maximum negative pressure ramp rate, indicated by the slope of line 194 after time T1. The negative pressure ramp rate can be controlled by controller 126 modulating purge valve 186.

At time T2, controller 126 notes that the first pressure signal is approaching P1, which is the minimum allowable pressure during a purging procedure. Accordingly, controller 126 brings the first purge cycle to an end, and causes a first pressurization cycle to commence. For this to happen, first control valve 188 is closed, and second control valve 190 is opened, thereby connecting compressor outlet 110 to pressurizing outlet 118. Compressor 106 is operated to cause hydrogen to be pumped into the storage tank. Controller 126 monitors the changing first pressure signal to ensure that the pressure is not exceeding the maximum pressure ramp rate, indicated by the slope of line 194 after time T2. The pressure ramp rate can be controlled by controller 126 modulating purge valve 186.

At time T3, controller 126 notes that the first pressure signal is approaching P2, which is the maximum allowable pressure during a purging procedure. Accordingly, controller 126 brings the first pressurization cycle to an end, and causes a second purge cycle to commence. For this to happen, first control valve 188 is opened, and second control valve 190 is closed. The second purge cycle then continues in a similar manner to the first purge cycle, although from near P2 rather than P5.

The pressurization and purge cycle repeats until the required number of cycles have been completed. At this point, shown as P4 in FIG. 8, the concentration of hydrogen within the storage tank is sufficient that it can be properly pressurized to its full operating pressure with hydrogen. Accordingly, in the pressurization cycle following T4, the hydrogen pressure is allowed to increase until it approaches P4, the maximum allowable operating pressure, which it reaches at time T5. At that time, compressor 106 is shut down. Rig 100 indicates, e.g. via user interface 136, that the purging procedure is finished.

Although the pressurization and purge cycles in FIG. 8 show linear pressure increases and decreases, the skilled person will appreciate that this need not be the case. For example, controller 126 may control the pressure ramp rate such that it flattens out as it approaches P1 and P2 respectively, to avoid sudden changes in delivery pressure and reducing the chance of pressure over- or under-shoots. The output of compressor 106 may similar be ramped up and down to avoid sudden changes in speed. It may also be desirable to allow a pause between each pressurization and purge cycle, allowing the pressure to stabilise and ensuring time for valves to open and close as required.

Also, although FIG. 8 shows a purge cycle being performed first, the skilled person will appreciate that the pressurization cycle may be performed first. In addition, it is not necessary for the pressure to be allowed to rise all the way to P2 and/or fall all the way to P1 during purge and pressurization cycles.

A hydrogen pressurization rig may be configured to operate in an reclamation mode in which controller 126 controls compressor 106 such that it reclaims hydrogen from a storage tank to which it is coupled. Previously described implementations, for example, may be configured such that they allow connection of supply inlet 112 to a storage tank, such as the storage tank of a vehicle. Compressor 106 can then be operated to extract hydrogen (or any other gas(es)) from the storage tank, and either vented through a suitable vent, or pressurized into a further tank connected to pressurizing outlet 118.

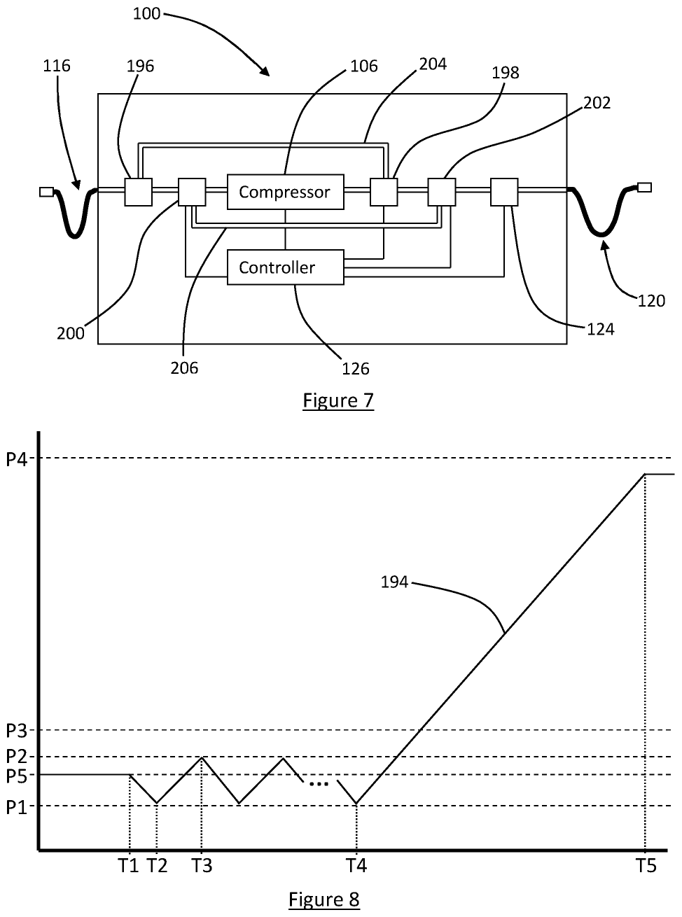

FIG. 7 shows an alternative implementation, in which components corresponding with those in previously described Figures are indicated with like reference signs. In FIG. 7, rig 100 includes a first reversal valve 196, a second reversal valve 198, a third reversal valve 200, and a fourth reversal valve 202.

First reversal valve 196 is a three way valve connected between supply inlet 112, compressor inlet 108 and one end of a first bypass conduit 204. Second reversal valve 198 is a three-way valve connected between compressor outlet 110, first pressure sensor 124 and a second end of first bypass conduit 204. Third reversal valve 200 is a three-way valve connected between compressor inlet 108, first reversal valve 196, and a first end of second bypass conduit 206. Fourth reversal valve 202 is a three-way valve connected between second reversal valve 198, first pressure sensor 124, and a second end of second bypass conduit 206.

Each of first reversal valve 196, second reversal valve 198, third reversal valve 200, and fourth reversal valve 202 is controlled by controller 126. In a first, ordinary mode of operation, the reversal valves are controlled by controller 126 such that hydrogen flows sequentially from MCP 114, through first reversal valve 196, third reversal valve 200, compressor 106, second reversal valve 198, and fourth reversal valve 202. In this mode, operation of compressor 106 acts to move hydrogen from MCP 114 and compress it into storage tank 102.

In a second, reversed mode of operation, the reversal valves are controlled by controller 126 such that hydrogen flows sequentially from storage tank 102, through fourth reversal valve 202, second bypass conduit 206, third reversal valve 200, compressor 106, second reversal valve 198, first bypass conduit 204, and first reversal valve 196. In this mode, operation of compressor 106 acts to move hydrogen from storage tank 102 and compress it into MCP 114.

These ordinary and reversed modes may be used one after the other to reclaim hydrogen from, for example, a vehicle requiring maintenance or service for which the vehicle's storage tank must be emptied or at least depressurized. Rather than venting the hydrogen to atmosphere, where it is wasted and can potentially contribute to global warming, the reversed mode is engaged, and the hydrogen in the vehicle's storage tank is reclaimed and pumped to another storage tank. This can be MCP 114, or any other suitable form of storage tank. When the maintenance or service is complete, the ordinary mode is engaged, and the hydrogen is re-extracted from the other storage tank back into the vehicle's storage tank.

The skilled person will appreciate that any hydrogen reclaimed in this way need not be returned to the actual vehicle from which it was reclaimed. It may, instead, be used to fuel a different vehicle, or transferred to another storage vessel.

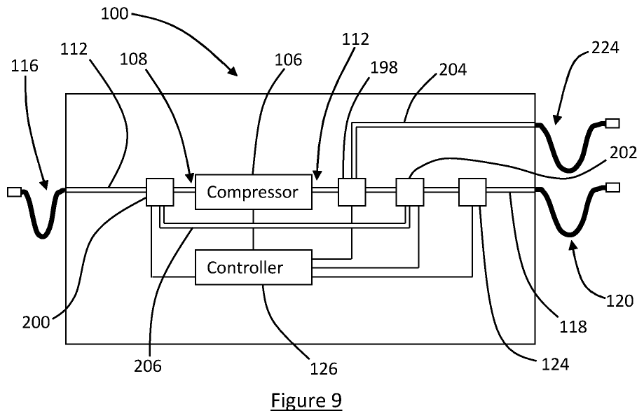

Turning to FIG. 9, there is shown an alternative implementation, in which components corresponding with those in FIGS. 1 to 4 and 7 are indicated with like reference signs. The implementation of FIG. 9 is configured to provide functionality similar to that described in relation to FIG. 7. Compared to the arrangement in FIG. 7, the rig 100 of FIG. 9 omits first valve 196, and connects first bypass conduit 204 to a pressurizing outlet.

In one mode, second valve 198, third valve 200 and fourth valve 202 are all set by controller 126 to a straight-through mode, such that compressor 106 acts to move gas from inlet hose 116, sequentially through third valve 200, compressor 106, second valve 198, and fourth valve 202, to pressurizing outlet 118. In this mode, rig 100 acts similarly to rig 100 in FIG. 1.

In a second mode, second valve 198, third valve 200 and fourth valve 202 are set by controller 126 such that pressurizing outlet 118 acts as an input. In this mode, compressor 106 acts to move gas from pressurizing outlet 118, sequentially through fourth valve 202, second conduit 206, third valve 200, compressor 106, second valve 198, and first conduit 204. First conduit 204 is connected to a further connector 204, which in this mode is connected to a hydrogen storage tank that is intended to store hydrogen reclaimed from the storage tank (e.g., a vehicle fuel tank) to which pressurizing outlet 118 is connected.

To reverse the operation, connector 224 can be swapped with outlet hose 120, which will cause hydrogen to be extracted from where it was stored and returned to the original storage tank from which it was reclaimed.

Alternatively, the storage tank where the hydrogen was stored can be connected to supply inlet 112, and rig 100 operated in the first, straight through mode described above.

As with previously described implementations, it is not necessary that reclaimed hydrogen be returned to the storage tank from which it was reclaimed.

The skilled person will appreciate that with additional valving, it is possible to arrange rig 100 of FIG. 9 such that both the reclaim and return procedures can be performed without having to swap connectors. For example, an outlet manifold with controllable valves, similar to the arrangement of FIG. 3, can be used to achieve such functionality, with suitable controller programming.

Optionally, two or more of the hydrogen pressurizing rigs may be connected in series to form a hydrogen pressurizing system. For example, a first hydrogen pressurizing rig can accept hydrogen from a hydrogen source such as an MCP or an electrolyser. The compressor of the first hydrogen pressurizing rig compresses the hydrogen and outputs it at a first pressure (450 bar, for example) to a second hydrogen pressurizing rig through a suitable connection hose. The second hydrogen pressurizing rig further compresses the hydrogen and outputs it at a second pressure (700 bar, for example) that is higher than the first pressure.

This modular approach allows for a greater range of input and/or output pressures, allowing for greater flexibility in matching input and output pressure requirements.

The illustrated implementations omit unnecessary details to avoid obscuring the subject matter of the invention. For example, the skilled person will be aware that elements such as connectors, non-return valves, drains, pressure reducing valves, safety interlocks, pressure and temperature based alarms and fail-safes, manually operated valves, and the like, will form part of any commercial rig of the general type described. The skilled person will appreciate that the same or similar functionality can be achieved with different valving and conduit arrangements. For example, the skilled person will appreciate that the described three-way valves can be replaced by a functionally-equivalent arrangement that uses two-way valves and additional conduits/joints as required.

The skilled person will also appreciate that each and every component and functional aspect of each implementation, including those in the drawings, may be combined with each other to the maximum extent possible. By way of non-exhaustive examples, one or more metering valves, such as metering valve 148, may be used in any implementation to modulate the flow of hydrogen. Similarly, an inlet and/or outlet manifold, such as inlet manifold 178 and outlet manifold 164 may be used in any implementation. Similarly, the reconfigurability of at least one pressurizing outlet such that it can be connected during a hydrogen reclaim procedure may be used in any implementation.

The invention has been described with reference to particular implementations. However, it will be appreciated that variations and modifications can be effected by a person of ordinary skill in the art without departing from the scope of the invention.

1. A hydrogen pressurizing rig for pressurizing a storage tank, the hydrogen pressurizing rig comprising:
a compressor comprising a compressor inlet and a compressor outlet;
a supply inlet coupled or couplable to a hydrogen source, the supply inlet fluidly coupled or couplable with the compressor inlet;
a pressurizing outlet for coupling to a storage tank to be pressurized, the pressurizing outlet fluidly coupled or couplable with the compressor outlet;
a first pressure sensor disposed for sensing a pressure during pressurizing of the storage tank and for outputting a first pressure signal based on the sensed pressure, the first pressure signal being indicative of a pressure within the storage tank; and
a controller coupled to receive the pressure signal, and being programmed and configured to control operation of the compressor such that, in use, the compressor pumps hydrogen from the supply inlet into the storage tank via the pressurizing outlet, such that a pressure ramp rate indicated by the pressure signal does not exceed a predetermined pressure ramp rate.

2. The hydrogen pressurizing rig of claim 1, comprising a user interface for receiving user input and providing it to the controller, wherein the predetermined pressure ramp rate is selectable by way of the user interface.

3. The hydrogen pressurizing rig of claim 1 or 2, comprising a metering valve fluidly coupled between the compressor outlet and the pressurizing outlet, the metering valve being connected for control by the controller so as to modulate a rate at which hydrogen is supplied to the storage tank.

4. The hydrogen pressurizing rig of claim 3, comprising a second pressure sensor disposed for sensing a pressure of the hydrogen source to which the supply inlet is coupled, and for outputting a second pressure signal based on the sensed pressure, wherein the controller is configured to control the metering valve to modulate the rate at which hydrogen is supplied to the storage tank based at least in part on a difference between the first and second pressure signals.

5. The hydrogen pressurizing rig of claim 4, wherein the controller is configured to operate the compressor only in the event that a difference between the first pressure signal and the second pressure signal is insufficient to cause hydrogen to flow from the hydrogen source to the storage tank at an acceptable rate.

6. The hydrogen pressurizing rig of any preceding claim, wherein the pressurizing outlet comprises a plurality of pressurizing connectors, each of the pressurizing connectors being configured for attachment to a different type of storage tank and/or connector.

7. The hydrogen pressurizing rig of any preceding claim, wherein the supply inlet comprises a plurality of supply connectors, each of the supply connectors being configured for attachment to a different type of hydrogen source and/or connector.

8. The hydrogen pressurizing rig of any preceding claim, comprising a frame to which the supply inlet, the pressurizing outlet, and the compressor are mounted, the hydrogen pressurizing rig being portable.

9. The hydrogen pressurizing rig of claim 8, comprising one or more ground wheels mounted to the frame for allowing the hydrogen fueling rig to be wheeled over ground.

10. The hydrogen pressurizing rig of any preceding claim, comprising a purge valve fluidly coupled with the pressurizing outlet and controllable by the controller, the hydrogen fueling rig being configured to operate in a mode for purging of a storage tank that contains a gas other than hydrogen, in which the controller is configured to:
(a) control the purge valve so as to partially purge a storage tank to which the pressurizing outlet is coupled, such that a pressure indicated by the pressure signal does not fall below a first pressure;
(b) partially fill the storage tank with hydrogen from a hydrogen source to which the supply inlet is coupled, such that a pressure indicated by the pressure signal does not rise above a second pressure; and
(c) repeat steps (a) and (b) a plurality of times;
wherein either or step (a) or step (b) may be performed first.

11. The hydrogen pressurizing rig of claim 10, wherein step (b) comprises operating the compressor.

12. The hydrogen pressurizing rig of claim 1, wherein the first pressure is a minimum conditioned operating pressure and/or the second pressure is lower than a minimum in-service rated pressure of the storage tank.

13. The hydrogen pressurizing rig of any preceding claim, operable in an reclaim mode in which the controller controls the compressor such that it extracts hydrogen from a storage tank to which it is coupled, the storage tank storing hydrogen for fueling a vehicle.

14. The hydrogen pressurizing rig of any preceding claim, comprising a further pressurizing outlet for coupling to a storage tank to be pressurized, the pressurizing outlet fluidly coupled or couplable with the compressor outlet;
at least one valve controllable by the controller for reconfiguring a fluid connection to at least one of the pressurizing outlets such that it is fluidly connected to the compressor inlet, such that hydrogen can be reclaimed from a storage tank through the reconfigured pressurizing outlet, and used by the compressor to pressurize a storage tank through one of the pressurizing outlets that is not reconfigured.

15. A hydrogen pressurizing rig comprising:
a compressor;
a first pressure sensor disposed downstream of the compressor for sensing a pressure of gas within a storage tank and for outputting a first pressure signal based on the sensed pressure, the first pressure signal being indicative of that pressure; and
a controller coupled to receive the pressure signal;
the hydrogen pressurization rig being configured to operate in a purge mode for purging of a storage tank that contains a gas other than hydrogen, in which the controller is configured to:
(a) control the purge valve so as to partially purge a storage tank to which the hydrogen fueling rig is coupled, such that a pressure indicated by the pressure signal does not fall below a first pressure;
(b) partially fill the storage tank with hydrogen from a hydrogen source to which the hydrogen fueling rig is coupled, such that a pressure indicated by the pressure signal does not rise above a second pressure; and
(c) repeat steps (a) and (b) a plurality of times;
wherein either or step (a) or step (b) may be performed first.

16. The hydrogen pressurizing rig of claim 14, wherein step (b) comprises operating the compressor.

17. The hydrogen pressurizing rig of claim 14 or 15, wherein the controller is configured to control the compressor such that a pressure ramp rate indicated by the pressure signal does not exceed a predetermined pressure ramp rate.

18. A hydrogen pressurizing system comprising:
a first hydrogen pressurizing rig according to any one of the preceding claims; and
a second hydrogen pressurizing rig according to any one of the preceding claims;
wherein the first hydrogen pressurizing rig compresses hydrogen and outputs it at a first pressure to the second hydrogen pressurizing rig, and the second hydrogen pressurizing rig further compresses the hydrogen and outputs it at a second pressure that is higher than the first pressure.
